(19) United States
(12) Patent Application Publication
(10) Pub. No.: US 2006/0119944 A1
(43) Pub. Date: Jun. 8, 2006

(54) Lens including a sub-wavelength grating

(75) Inventor: Tai-Cherng Yu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Chen City (TW)

(21) Appl. No.: 11/261,117

(22) Filed: Oct. 28, 2005

(30) Foreign Application Priority Data
Dec. 4, 2004 (CN) 200410077279.X

(51) Int. Cl. G02B 5/18

(52) U.S. Cl. 359/569

(57) ABSTRACT

A lens (100) includes a first lens surface (1) and a second lens surface (2). At least one of the first lens surface (1) and the second lens surface (2) has a sub-wavelength grating (3) associated therewith. The sub-wavelength grating has a period shorter than any wavelength of visible light. The sub-wavelength grating includes a plurality of grating members (6), each having a length and a width, respectively, each shorter than any wavelength of visible light.

### BACKGROUND OF THE INVENTION

1. Field of the Invention

The present invention generally relates to lenses and, more particularly, to a lens for a camera.

2. Discussion of the Related Art

Currently, digital camera modules are included as a feature in a wide variety of portable electronic devices. Most portable electronic devices are becoming progressively more miniaturized over time, and digital camera modules are correspondingly becoming smaller and smaller. Nevertheless, in spite of the small size of a contemporary digital camera module, consumers still demand excellent imaging. The image quality of a digital camera is mainly dependent upon the optical elements of the digital camera module.

Lenses are very important elements in the digital camera module. FIG. 3 shows a contemporary lens 10. When light passes through the contemporary lens 10, a Fresnel loss tends to occur because the refractive index of the lens 10 is different from that of the air. The Fresnel loss decreases the luminance of the light, which deteriorates the resolving power of the lens 10. The visible light includes different rays having different wavelengths. Therefore, when the visible light passes through the lens 10, the different rays will not focus on a same point, which makes the lens 10 have an aberration problem.

An AR coating (anti-reflection coating) is generally used to help diminish the Fresnel loss of the lens 10 and improve the luminance of the light. However, the AR coating can not resolve the aberration issue.

What is needed is a lens for a camera which can resolve the problem of aberration.

### SUMMARY OF THE INVENTION

A lens includes a first lens surface and a second lens surface. At least one of the first lens surface and the second lens surface has a sub-wavelength grating associated therewith. The sub-wavelength grating has a period shorter than any wavelength within a wavelength range of visible light. Further, the sub-wavelength grating has a length and a width, respectively, each shorter than any wavelength within a wavelength range of visible light.

Other objects, advantages and novel features will become more apparent from the following detailed description, when taken in conjunction with the accompanying drawings.

### BRIEF DESCRIPTION OF THE DRAWINGS

Many aspects of the lens can be better understood with reference to the following drawings. The components in the drawings are not necessarily to scale, the emphasis instead being placed upon clearly illustrating the principles of the present lens. Moreover, in the drawings, like reference numerals designate corresponding parts throughout the several views.

FIG. 1 is a schematic, side view of a lens in accordance with a preferred embodiment of the lens;

FIG. 2 is a schematic view of a sub-wavelength grating in FIG 1; and

FIG. 3 is a schematic, side view of a contemporary lens.

### DETAILED DESCRIPTION OF THE EMBODIMENTS

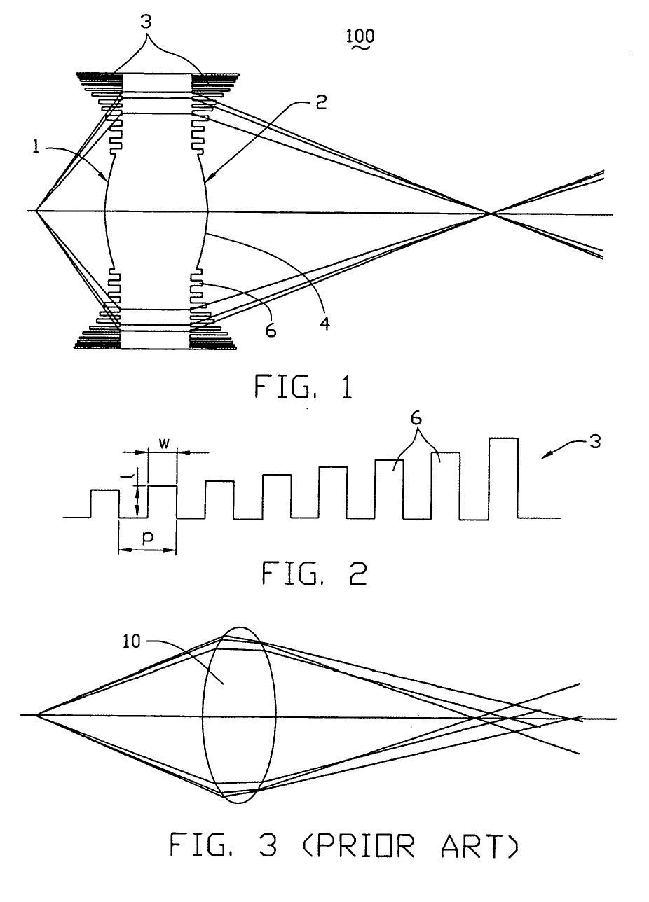

Referring to FIG. 1, a lens 100 of a preferred embodiment includes a first lens surface 1 and a second lens surface 2. A sub-wavelength grating 3 is symmetrically formed on the first lens surface 1 and/or the second lens surface 2. An AR coating 4 is advantageously deposited (at least) on the middle portions of the first lens surface 1 and/or the second lens surface 2. Since most problem of aberration occurs on the edges of the contemporary lens 10, the sub-wavelength grating 3 is advantageously symmetrically formed on the edges of the first lens surface 1 and/or the second lens surface 2. It is to be understood, however, that the incorporation of any sub-wavelength grating at any particular location on either of lens surfaces 1 or 2 is considered to broadly be within the scope of the present lens 100.

Referring to FIG. 2, the sub-wavelength grating 3 includes a plurality of grating members 6 and has a period P, the period P being shorter than any wavelength within the wavelength range of visible light. The period P of the sub-wavelength grating 3 is advantageously shorter than about 1 micron. The grating members 6 of the sub-wavelength grating 3 each usefully have a rectangular cross section. Accordingly, each grating member 6 has a length l and a width w, respectively. The length l and the width w each are chosen so as to be shorter than any of the wavelengths in the range of visible light. The length l and the width w are, like the period P, preferably shorter than about 1 micron. In the sub-wavelength grating 3, the period P and the width w keep a changeless numerical value (i.e., remain constant), and the length l of adjacent grating members 6 progressively increases by degrees/incremental amounts. Note that FIG. 1, unlike FIG. 2, is not drawn to relative scale with respect to widths w and periods P, in order to allow a better schematic illustration of lens 100, as a whole.

The sub-wavelength grating 3 has an effective refractive index n_{eff}. The effective refractive index n_{eff} is more than a refractive index n₀ of the visible light in air. In addition, the effective refractive index n_{eff} is less than a refractive index n₂ of the visible light in the lens 100. When the visible light passes through the lens 100, the visible light is first refracted between the air and the sub-wavelength grating 3, with the refractive index changing from n₀ to n_{eff}. Then the visible light is refracted between the sub-wavelength grating 3 and the lens 100 with the refractive index changing from n_{eff} to n₂. Therefore, as the refractive index does not directly change from n₀ to n₂, the lens of the preferred embodiment can reduce the Fresnel loss. When the visible light passes through the sub-wavelength grating 3, the visible light will be diffracted, and such diffracted visible light can advantageously display reduced aberration problems.

For mass production, the lens 100 can be manufactured by a method of pressing mold. It is to be understood that the sub-wavelength grating 3 can instead be engraved on the surface of the lens 100.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A lens, comprising:
a first lens surface; and
a second lens surface, at least one of the first lens surface and the second lens surface including a sub-wavelength grating, the sub-wavelength grating having a period shorter than any wavelength within a wavelength range of visible light.

2. The lens as claimed in claim 1, wherein the sub-wavelength grating includes a plurality of grating members, each grating member having a length and a width, respectively, the length and the width each being shorter than any wavelength within a wavelength range of visible light.

3. The lens as claimed in claim 2, wherein the length of each adjacent grating member incrementally increases.

4. The lens as claimed in claim 2, wherein the period of the sub-wavelength grating and the width of each grating member are each constant.

5. The lens as claimed in claim 2, wherein the period of the sub-wavelength grating, the length of each grating member, and the width of each grating member are shorter than about 1 micron, respectively.

6. The lens as claimed in claim 1, wherein the sub-wavelength grating includes a plurality of grating members, each grating member having a rectangular cross section.

7. The lens as claimed in claim 1, wherein the first lens surface and the second lens surface, respectively, have one of the sub-wavelength gratings formed thereon.

8. The lens as claimed in claim 7, wherein the sub-wavelength grating is symmetrically formed on edges of the first lens surface and the second lens surface, respectively.

9. The lens as claimed in claim 1, wherein an AR coating is formed at least on a middle of at least one of the first lens surface and the second lens surface.
